(19) United States
(12) Patent Application Publication
(10) Pub. No.: US 2012/0025421 A1
(43) Pub. Date: Feb. 2, 2012

(54) METHOD FOR PRODUCING LIQUID CRYSTAL POLYESTER COMPOSITION

(75) Inventors: Yoshiyuki FUKUHARA, Tsuchiura-shi (JP); Yasuo MATSUMI, Tsukuba-shi (JP)

(73) Assignee: SUMITOMO CHEMICAL COMPANY, LIMITED, Tokyo (JP)

(21) Appl. No.: 13/193,017

(22) Filed: Jul. 28, 2011

(30) Foreign Application Priority Data
Jul. 30, 2010 (JP) 2010-171898

(51) Int. Cl. B29C 33/62; C09K 19/38; C09K 19/54

(52) U.S. Cl. 264/300; 252/299.5

(57) ABSTRACT

The present invention provides a method for producing a liquid crystal polyester composition, the method comprising feeding a liquid crystal polyester and a polyhydric alcohol fatty acid ester into an extruder having a vent portion, followed by melt-kneading in a state where the degree of decompression of the vent portion is −0.06 MPa or less in terms of a gauge pressure. The composition obtained by the method can provide a molded article having a thin wall portion and complicated shape.

### BACKGROUND OF THE INVENTION

1. Field of the Invention

The present invention relates to a method for producing a liquid crystal polyester which may comprise a liquid crystal polyester and a mold release agent.

2. Description of the Related Art

A liquid crystal polyester has high heat resistance and strength and is excellent in melt fluidity, and is therefore used as a molding material for the production of various products and components, including electric and electronic components. Particularly, due to its feature that it is excellent in melt fluidity, a liquid crystal polyester is preferably used as a molding material for the production of a molded article having a thin wall portion and a molded article having a complicated shape. However, in molding the liquid crystal polyester, it is sometimes difficult to remove a molded article from a mold used for molding, that is, the liquid crystal polyester is inferior in mold releasability, and thus the removal of the molded article may be laborious and the molded article may be deformed. Therefore, it has been studied to blend the liquid crystal polyester with a mold release agent. For example, JP-A-2-208353 describes that a pentaerythritol fatty acid ester is used as the mold release agent, and JP-A-2009-108297 describes that a predetermined polyhydric alcohol fatty acid ester is used as the mold release agent. In addition, it is also known that a liquid crystal polyester composition can be obtained by feeding a liquid crystal polyester and a mold release agent into an extruder, followed by melt kneading (see, JP-A-2-208353 and JP-A-2009-108297).

### SUMMARY OF THE INVENTION

In the method described in JP-A-2-208353, the obtained liquid crystal polyester composition does not necessarily have sufficient mold releasability. In the method described in JP-A-2009-108297, the obtained liquid crystal polyester composition is excellent in mold releasability. However, blisters (blisters on a surface) are likely to arise at a high temperature during a soldering treatment or the like. Thus, an object of the present invention is to provide a method capable of producing a liquid crystal polyester composition which is excellent in mold releasability and is less likely to cause blisters at a high temperature.

In order to achieve the above object, the present invention provides a method for producing a liquid crystal polyester composition, the method comprising feeding a liquid crystal polyester and a polyhydric alcohol fatty acid ester into an extruder having a vent portion, followed by melt-kneading in a state where the degree of decompression of the vent portion is −0.06 MPa or less in terms of a gauge pressure.

Further, the present invention provides a method for producing a liquid crystal polyester molded article by using the liquid crystal polyester composition described above.

According to the present invention, it is possible to produce a liquid crystal polyester composition which is excellent in mold releasability and is less likely to cause blisters at a high temperature, and it is also possible to advantageously produce a molded article having a thin wall portion and a molded article having a complicated shape by molding the liquid crystal polyester composition.

### BRIEF DESCRIPTION OF THE DRAWINGS

FIG. 1 is a diagram showing a mold used in the measurement of mold release resistance in Examples.

### DETAILED DESCRIPTION OF THE INVENTION

A liquid crystal polyester is preferably a liquid crystal polyester which exhibits liquid crystallinity in a molten state, and is melted at a temperature of 450° C. or lower. The liquid crystal polyester may be a liquid crystal polyester amide, a liquid crystal polyester ether, a liquid crystal polyester carbonate, or a liquid crystal polyester imide. The liquid crystal polyester is preferably a wholly aromatic liquid crystal polyester which is prepared by using only an aromatic compound as a raw material monomer.

Typical examples of the liquid crystal polyester include a liquid crystal polyester obtained by polymerizing (polycondensing) an aromatic hydroxycarboxylic acid, an aromatic dicarboxylic acid, and a compound selected from the group consisting of an aromatic diol, an aromatic hydroxyamine and an aromatic diamine; a liquid crystal polyester obtained by polymerizing plural kinds of aromatic hydroxycarboxylic acids; a liquid crystal polyester obtained by polymerizing an aromatic dicarboxylic acid, and a compound selected from the group consisting of an aromatic diol, an aromatic hydroxyamine and an aromatic diamine; and a liquid crystal polyester obtained by polymerizing a polyester such as polyethylene terephthalate, and an aromatic hydroxycarboxylic acid. Herein, in place of a part or all of each of the aromatic hydroxycarboxylic acid, the aromatic dicarboxylic acid, the aromatic diol, the aromatic hydroxyamine and the aromatic diamine, a polycondensable derivative thereof may be used.

Examples of the polycondensable derivative of a compound having a carboxyl group, such as an aromatic hydroxycarboxylic acid or an aromatic dicarboxylic acid, include a polycondensable derivative in which the carboxyl group has been converted into an alkoxycarbonyl group or an aryloxycarbonyl group, a polycondensable derivative in which the carboxyl group has been converted into a haloformyl group, and a polycondensable derivative in which the carboxyl group has been converted into an acyloxycarbonyl group. Examples of the polycondensable derivative of a compound having a hydroxyl group, such as an aromatic hydroxycarboxylic acid, an aromatic diol or an aromatic hydroxylamine, include a polycondensable derivative in which the hydroxyl group has been converted into an acyloxyl group through acylation. Examples of the polycondensable derivative of a compound having an amino group, such as an aromatic hydroxyamine or an aromatic diamine, include a polycondensable derivative in which the amino group has been converted into an acylamino group through acylation.

The liquid crystal polyester is preferably a liquid crystal polyester having a repeating unit represented by the formula (1) shown below (hereinafter may be sometimes referred to as a “repeating unit (1)”), and more preferably a liquid crystal polyester further having a repeating unit represented by the formula (2) shown below (hereinafter may be sometimes referred to as a “repeating unit (2)”) and a repeating unit represented by the formula (3) shown below (hereinafter may be sometimes referred to as a “repeating unit (3)”):

—O—Ar¹—CO—, (1)

—CO—Ar²—CO—, (2)

—X—Ar³—Y—, (3)

wherein Ar¹ represents a phenylene group, a naphthylene group or a biphenylylene group, Ar² and Ar³ each independently represent a phenylene group, a naphthylene group, a biphenylylene group or a group represented by the formula (4) shown below, X and Y each independently represent an oxygen atom or an imino group (—NH—), and hydrogen atoms in the above group represented by Ar¹, Ar² or Ar³ each independently may be substituted with a halogen atom, an alkyl group or an aryl group, and

—Ar⁴—Z—Ar⁵— (4)

wherein Ar⁴ and Ar⁵ each independently represent a phenylene group or a naphthylene group, and Z represents an oxygen atom, a sulfur atom, a carbonyl group, a sulfonyl group or an alkylidene group.

Herein, examples of the halogen atom include a fluorine atom, a chlorine atom and a bromine atom. Examples of the alkyl group include a methyl group, an ethyl group, an n-propyl group, an isopropyl group, an n-butyl group, an isobutyl group, an s-butyl group, a t-butyl group and a 2-ethylhexyl group, and the number of carbon atoms thereof is usually from 1 to 10. Examples of the aryl group include a phenyl group, an o-tolyl group, an m-tolyl group, a p-tolyl group, a 1-naphthyl group and a 2-naphthyl group, and the number of carbon atoms thereof is usually from 6 to 20. Examples of the alkylidene group include a methylene group, an ethylidene group, an isopropylidene group, an n-butylidene group and a 2-ethylhexylidene group, and the number of carbon atoms thereof is usually from 1 to 10.

The repeating unit (1) is a repeating unit derived from an aromatic hydroxycarboxylic acid, and Ar¹ is preferably a p-phenylene group (derived from p-hydroxybenzoic acid) or a 2,6-naphthylene group (derived from 6-hydroxy-2-naphthoic acid).

The repeating unit (2) is a repeating unit derived from an aromatic dicarboxylic acid. Ar² is preferably a p-phenylene group (derived from terephthalic acid), an m-phenylene group (derived from isophthalic acid) or a 2,6-naphthylene group (derived from 2,6-naphthylene dicarboxylic acid).

The repeating unit (3) is a repeating unit derived from an aromatic diol, an aromatic hydroxylamine or an aromatic diamine, and Ar³ is preferably a p-phenylene group (derived from hydroquinone, p-aminophenol or p-phenylenediamine) or a 4,4′-biphenylylene group (derived from 4,4′-dihydroxybiphenyl, 4-amino-4′-hydroxybiphenyl or 4,4′-diaminobiphenyl).

The content of the repeating unit (1) is preferably 30 mol % or more, more preferably from 30 to 80 mol %, and still more preferably from 40 to 70 mol %, based on the total amount of all repeating units which constitute the liquid crystal polyester (the value of the sum total of an amount (mol) equivalent to the amount of substance of each repeating unit determined by dividing the mass of each repeating unit constituting a liquid crystal polyester by the formula weight of each repeating unit). As the content of the repeating unit (1) increases, liquid crystallinity of the liquid crystal polyester is improved more easily. However, when the content is too high, a melting temperature of the liquid crystal polyester becomes higher and thus it becomes difficult to mold the liquid crystal polyester.

The content of the repeating unit (2) is preferably 35 mol % or less, more preferably from 10 to 35 mol %, and still more preferably from 15 to 30 mol %, based on the total amount of all repeating units which constitute the liquid crystal polyester.

The content of the repeating unit (3) is preferably 35 mol % or less, more preferably from 10 to 35 mol %, and still more preferably from 15 to 30 mol %, based on the total amount of all repeating units which constitute the liquid crystal polyester.

A ratio of the content of the repeating unit (2) to that of the repeating unit (3) is preferably from 0.9/1 to 1/0.9 in terms of [repeating unit (2)]/[repeating unit (3)] (mol/mol) since the molecular weight of the liquid crystal polyester becomes higher easily, thus facilitating enhancement in heat resistance and strength of the liquid crystal polyester.

It is preferred that the repeating unit (3) is a repeating unit in which X and Y are oxygen atoms, that is, a repeating unit derived from an aromatic diol since the viscosity of the liquid crystal polyester upon melting becomes lower easily.

It is preferred that the liquid crystal polyester is produced by melt polymerization of a raw material monomer, followed by solid phase polymerization of the obtained polymer (prepolymer). Whereby, a high-molecular weight liquid crystal polyester having high heat resistance and high strength can be produced with satisfactory operability. The above melt polymerization may be performed in the presence of a catalyst, and examples of the catalyst include metal compounds such as magnesium acetate, stannous acetate, tetrabutyl titanate, lead acetate, sodium acetate, potassium acetate and antimony trioxide; and nitrogen-containing heterocyclic compounds such as N,N-dimethylaminopyridine and N-methylimidazole. Among these catalysts, nitrogen-containing heterocyclic compounds are preferably used.

The flow initiation temperature of the liquid crystal polyester is preferably 270° C. or higher, and more preferably 280° C. or higher, and is usually 400° C. or lower, and preferably 380° C. or lower. As the flow initiation temperature of the liquid crystal polyester becomes higher, heat resistance and strength of the liquid crystal polyester are improved more easily. However, when the flow initiation temperature is too high, a melting temperature of the liquid crystal polyester becomes higher and thus it becomes difficult to mold the liquid crystal polyester.

The flow initiation temperature is also called a flow temperature, and is the temperature at which, when a hot melt of a liquid crystal polyester is extruded through a nozzle of a capillary rheometer measuring 1 mm in inner diameter and 10 mm in length under a load of 9.8 MPa (100 kg/cm²) at a temperature rise rate of 4° C./minute, the melt viscosity exhibits 4,800 Pa·s (48,000 poise). The flow initiation temperature serves as an indicator of the molecular weight of the liquid crystal polyester (see, for example, “Synthesis, Molding and Application of Liquid Crystal Polymer”, edited by Naoyuki Koide, p. 95, CMC, issued on Jun. 5, 1987).

The polyhydric alcohol fatty acid ester to be blended with the liquid crystal polyester may be a partial ester or a full ester which is obtained by condensing a fatty acid and a polyhydric alcohol, or may be a mixture of two or more kinds. The partial ester is an ester obtained by acylating a part of hydroxyl groups of a polyhydric alcohol with a fatty acid, and the full ester is an ester obtained by acylating all hydroxyl groups of a polyhydric alcohol with a fatty acid.

The fatty acid is preferably a higher fatty acid having 10 to 32 carbon atoms, and examples thereof include saturated fatty acids such as decanoic acid, undecanoic acid, dodecanoic acid, tridecanoic acid, tetradecanoic acid, pentadecanoic acid, hexadecanoic acid (palmitic acid), heptadecanoic acid, octadecanoic acid (stearic acid), nonadecanoic acid, icosanoic acid, docosanoic acid and hexacosanoic acid; and unsaturated fatty acids such as palmitoleic acid, oleic acid, linoleic acid, linolenic acid, eicosenoic acid, eicosapentaenoic acid and setoleic acid. If necessary, two or more kinds of them may be used. Among them, a fatty acid having 10 to 22 carbon atoms is preferred and a fatty acid having 14 to 20 carbon atoms is more preferred.

The polyhydric alcohol is a compound having two or more alcoholic hydroxyl groups in a molecule, and a polyhydric alcohol having 3 to 32 carbon atoms is preferred. Examples thereof include polyglycerins such as glycerin, diglycerin and decaglycerin; pentaerythritol, dipentaerythritol, diethylene glycol and propylene glycol. If necessary, two or more kinds of them may be used. Among these, pentaerythritol and dipentaerythritol are preferred from the viewpoint of heat resistance of the obtained polyhydric alcohol fatty acid ester.

The polyhydric alcohol fatty acid ester can be obtained by esterifying a polyhydric alcohol and a fatty acid through dehydration polycondensation. In case of esterification, a partial ester or a full ester can be made separately by appropriately adjusting the amount of the hydroxyl group of the polyhydric alcohol and the amount of the fatty acid.

In the polyhydric alcohol fatty acid ester, a 5% weight loss temperature (TB) determined by thermogravimetric analysis (TGA) is preferably 250° C. or higher, and more preferably 280° C. or higher. When this 5% weight loss temperature is too low, the polyhydric alcohol fatty acid ester may be thermally decomposed during molding of the composition.

The blend amount of the polyhydric alcohol fatty acid ester is preferably from 0.1 to 1 part by mass, and more preferably from 0.1 to 0.5 parts by mass, based on 100% parts by mass of the liquid crystal polyester. When the blend amount of the polyhydric alcohol fatty acid ester is too large, the amount of the polyhydric alcohol fatty acid ester, which is unevenly distributed on a surface of the molded article, excessively increases, and thus it becomes difficult to sufficiently prevent the generation of blisters. When the blend amount is too small, the amount of the polyhydric alcohol fatty acid ester, which is unevenly distributed on a surface of the molded article, becomes insufficient, and thus it becomes difficult to exhibit satisfactory mold releasability.

The liquid crystal polyester may be optionally blended with one or more kinds of inorganic fillers. This inorganic filler may be a fibrous filler, a plate-like filler or a granular filler. Examples of the fibrous filler include a glass fiber, a PAN-based- or pitch-based carbon fiber, a silicon carbide fiber, a gypsum fiber, a ceramic fiber, a metal fiber such as a stainless steel fiber, an aluminum fiber or a brass fiber, a zirconia fiber, an alumina fiber, a silica fiber, an alumina silicate fiber, a titanium oxide fiber, a boron fiber, a potassium titanate whisker, a barium titanate whisker, a calcium carbonate whisker, a wollastonite whisker, an aluminum borate whisker, a zinc oxide whisker, a silicon nitride whisker, a silicon carbide whisker and asbestos. Examples of the plate-like filler include smectites such as montmorillonite, bidellite, nontronite, saponite, sauconite, stevensite, Na-hectorite, Li-hectorite; layered polysilicates such as kanemite and kenyaite; micas such as phlogopite, muscovite, sericite, fluorine bearing phlogopite, tetrasilicic fluoromica, sodium tetrasilicic fluoromica, Na-taeniolite and Li-taeniolite; white lead, talc, wollastonite, bentonite, kaolin, halloysite, vermiculite, chlorite, pyrophyllite, clay, zirconium phosphate, titanium phosphate, graphite, alumina, zeolite, magnesium hydroxide, aluminum hydroxide, zirconium hydroxide, boron nitride, iron oxide, calcium carbonate, calcium sulfate, barium sulfate and glass flake. Examples of the granular filler include silica, titanium oxide, ceramic beads, glass beads, hollow glass beads, carbon black, alumina, zeolite, magnesium hydroxide, aluminum hydroxide, magnesium oxide, zirconium oxide, boron nitride, silicon carbide, iron oxide, calcium carbonate, magnesium carbonate, and calcium sulfate.

The liquid crystal polyester may be optionally blended with one or more kinds of additives, for example, colorants such as a dye and a pigment, antioxidants, heat stabilizers, ultraviolet absorbers, antistatic agents and surfactants.

In the present invention, a liquid crystal polyester composition is produced by melt-kneading a liquid crystal polyester and a polyhydric alcohol fatty acid ester and, if necessary, together with other components. The respective components may be fed into an extruder having a vent portion, and then be melt-kneaded in a state where the degree of decompression of the vent portion is −0.06 MPa or less, and preferably −0.07 MPa or less, in terms of a gauge pressure. With this method, a liquid crystal polyester composition which is less likely to cause blisters at a high temperature can be obtained.

Examples of the extruder include a single-screw extruder and a twin-screw extruder, which is equipped with a single- or multi-stage vent. As the twin-screw extruder, twin-screw extruders from a twin-screw extruder with a unidirectionally rotating single thread screw to a twin-screw extruder with a triple thread screw can be used, and the twin-screw extruder may be a counter-rotating, parallel shaft, inclined shaft or incompletely engaged type twin-screw extruder. Among these twin-screw extruders, a unidirectionally rotating twin-screw extruder with one or more vents is preferred.

A screw diameter of the extruder is preferably 50 mm or less, and more preferably 45 mm or less. A ratio (L/D) of a full length (L) to an overall width (D) of a cylinder of an extruder is preferably 50 or more, and more preferably 60 or more. When the screw diameter is equal to or larger than the above predetermined value and L/D is equal to or larger than the above predetermined value, since deaeration is sufficiently performed by decompression of the vent portion and a volatile component is less likely to remain in the composition, it is possible to obtain a liquid crystal polyester composition with which the generation of blisters at a high temperature is more suppressed.

A screw element, which determines a screw design, is usually composed of an element for transportation composed of a forward flight, an element for plasticizing portion, and an element for kneading portion. In case of the twin-screw extruder, the plasticizing portion and the kneading portion are commonly constituted by using screw elements such as a reverse flight, a seal ring, a forward kneading disk and a reverse kneading disk in combination.

It is preferred that an opening length of the vent portion is 0.5 to 5 times larger than the screw diameter. When the opening length of the vent portion is too small, an insufficient deaeration effect is exerted. When the opening length of the vent portion is too large, foreign matters may enter from the vent portion and vent-up (a phenomenon that a molten resin ascends from the vent portion) may arise, and also a transportation and kneading ability may deteriorate.

It is preferred that an opening width of the vent portion is 0.3 to 1.5 times larger than the screw diameter. When the opening width of the vent portion is too small, an insufficient deaeration effect is exerted. When the opening width of the vent portion is too large, foreign matters may enter from the vent portion and vent-up (a phenomenon that a molten resin ascends from the vent portion) may arise, and also a transportation and kneading ability may deteriorate.

The vent portion is usually decompressed using a pump, and examples of the pump include a water seal type pump, a rotary pump, an oil diffusion pump and a turbo-pump.

It is preferred to provide a seal portion, into which the molten composition is completely filled, at the upstream side of the vent portion. In case of the twin-screw extruder, a screw shape having a pressure rising ability geometrically to the screw rotation, such as a seal ring or a reverse kneading, in addition to a reverse flight, is suitably used as a screw shape constituting the seal portion. The seal portion may be optionally constituted using an element such as a kneading disk in combination.

In order to prevent vent-up in the vent portion, the structure of the screw element of the vent portion is preferably a structure which enables a decrease in barrel inner pressure of a forward flight, a forward kneading disk and the like. It is preferred that the forward flight portion has a larger pitch since the barrel inner pressure becomes lower. For the same reason, it is preferred to provide a screw structure having a high transportation ability in front of the vent portion.

The respective components are usually fed to a feed port through a quantitative or volumetric feeder. Examples of the feed system of the quantitative feeder include a belt system, a screw system, a vibration system and a table system.

The feed position of the respective components is appropriately selected. When using a fibrous filler, in order to uniformly perform melt kneading, it is preferred that a liquid crystal polyester and a polyhydric alcohol fatty acid ester are fed through a feed port at the upstream side and a fibrous filler is fed through a feed port at the downstream side.

It is preferred that the vent portion is provided at the downstream side of the feed port at the downstream side since it is possible to obtain a liquid crystal polyester composition with which the generation of blisters at a high temperature can be further suppressed. It is more preferred that a vent portion is provided at each of the upstream side and the downstream side of the feed port at the downstream side since it is possible to obtain a liquid crystal polyester composition with which the generation of blisters at a high temperature can be further suppressed. When the vent portion is provided in the vicinity of the feed port at the upstream side, or provided in the upstream side of the feed port at the downstream side, melting of the liquid crystal polyester in the vicinity thereof may become insufficient and thus the effect of deaeration may not be sufficiently obtained.

It is possible to obtain a molded article, which is less likely to cause blisters at a high temperature, by melt molding of the composition thus obtained. The molding method is preferably an injection molding method, and it is more preferred that injection molding is performed at a temperature which is 10 to 80° C. higher than the flow initiation temperature of a liquid crystal polyester contained in the composition. When the molding temperature is within this range, the composition exhibits excellent melt fluidity and can exhibit satisfactory moldability even in the case of molding the composition into a connector having a thin wall portion having a wall thickness of 1 mm or less, or a connector having a complicated shape.

Examples of products and components obtained as a molded article include a casing for electric and electronic equipment, and electric equipment components such as a generator, an electric motor, an electric transformer, a current transformer, a voltage regulator, a rectifier, an inverter, an electric relay, a power contact, a switch, a breaker, a knife switch, a multipole rod, an electric component cabinet, a socket and a relay case. Examples thereof further include electronic components such as a sensor, an LED lamp, a lamp socket, a lamp reflector, a lamp housing, a connector, a small switch, a coil bobbin, a capacitor, an oscillator, various terminal boards, a transformer, a plug, a printed board, a compact motor, a magnetic head base, a power module, hard disk drive components (a hard disk drive hub, an actuator, a hard disk substrate, etc.) and DVD components (an optical pickup, etc.). Examples thereof further include a sealing resin of a semiconductor device, a coil or the like, components for optical instrument such as a camera, components such as a bearing which generates high frictional heat, heat radiation members and electric component insulating plates, such as automobile- and vehicle-related components. Among these, a coil bobbin and a connector, which has a comparatively complicated shape and may have a thin wall portion, are preferred.

The invention being thus described, it will be apparent that the same may be varied in many ways. Such variations are to be regarded as within the spirit and scope of the invention, and all such modifications as would be apparent to one skilled in the art are intended to be within the scope of the following claims.

### EXAMPLES

The present invention is described in more detail by following Examples, which should not be construed as a limitation upon the scope of the present invention.

### Examples 1 to 4 and Comparative Examples 1 to 4

### Liquid Crystal Polyester (1):

In a reactor equipped with a stirrer, a torque meter, a nitrogen gas introducing tube, a thermometer and a reflux condenser, 994.5 g (7.2 mol) of p-hydroxybenzoic acid, 446.9 g (2.4 mol) of 4,4′-dihydroxybiphenyl, 299.0 g (1.8 mol) of terephthalic acid, 99.7 g (0.6 mol) of isophthalic acid and 1347.6 g (13.2 mol) of acetic anhydride were charged. After sufficiently replacing the atmosphere inside the reactor by a nitrogen gas, the temperature was raised to 150° C. over 30 minutes under a nitrogen gas flow and the mixture was refluxed for 3 hours while maintaining the same temperature. Thereafter, 2.4 g of 1-methylimidazole was added and the temperature was raised to 320° C. over 2 hours and 50 minutes while distilling off the distilled by-produced acetic acid and unreacted acetic anhydride. At the time when an increase in torque was recognized, contents were taken out and cooled to room temperature. The obtained solid matter was crushed by a coarse crusher. After the temperature was raised to 250° C. from room temperature over 1 hour under a nitrogen atmosphere, the temperature was raised to 295° C. from 250° C. over 5 hours and then solid phase polymerization was performed while maintaining the temperature at 295° C. for 3 hours to obtain a liquid crystal polyester (1) having a flow initiation temperature of 320° C.

### Liquid Crystal Polyester (2):

In a reactor equipped with a stirrer, a torque meter, a nitrogen gas introducing tube, a thermometer and a reflux condenser, 994.5 g (7.2 mol) of p-hydroxybenzoic acid, 446.9 g (2.4 mol) of 4,4′-dihydroxybiphenyl, 239.2 g (1.44 mol) of terephthalic acid, 159.5 g (0.96 mol) of isophthalic acid and 1347.6 g (13.2 mol) of acetic anhydride were charged. After sufficiently replacing the atmosphere inside the reactor by a nitrogen gas, the temperature was raised to 150° C. over 30 minutes under a nitrogen gas flow and the mixture was refluxed for 3 hours while maintaining the same temperature. Thereafter, 2.4 g of 1-methylimidazole was added and the temperature was raised to 320° C. over 2 hours and 50 minutes while distilling off the distilled by-produced acetic acid and unreacted acetic anhydride. At the time when an increase in torque was recognized, contents were taken out and cooled to room temperature. The obtained solid matter was crushed by a coarse crusher. After the temperature was raised to 220° C. from room temperature over 1 hour under a nitrogen atmosphere, the temperature was raised to 240° C. from 220° C. over 0.5 hours and then solid phase polymerization was performed while maintaining the temperature at 240° C. for 10 hours to obtain a liquid crystal polyester (2) having a flow initiation temperature of 290° C.

### Mold Release Agent:

The followings were used as mold release agents. Mold release agent (1): “VPG2571” (a mixture of a full ester (hexastearate) of dipentaerythritol and stearic acid, and a partial ester, 5% weight loss temperature: 260° C.), manufactured by Cognis Oleo Chemicals Japan Ltd. Mold release agent (2): “VPG861” (a mixture of a full ester (tetrastearate) of pentaerythritol and stearic acid, and a partial ester, 5% weight loss temperature: 310° C.), manufactured by Cognis Oleo Chemicals Japan Ltd.

The weight loss temperature of the mold release agents (1) and (2) was determined by the following procedure.

### Measurement of 5% Weight Loss Temperature:

Using an apparatus for thermogravimetry (“DTG-60”, manufactured by Shimadzu Corporation), thermogravimetric analysis was carried out in a nitrogen atmosphere under the conditions of an initiation temperature of 30° C., a completion temperature of 500° C. and a temperature rise rate of 20° C./minute. The weight of a sample at the initiation temperature of 30° C. was assumed as 100%, and the temperature at which the sample weight reached 95% by a temperature rise was regarded as a 5% weight loss temperature.

### Liquid Crystal Polyester Composition:

A liquid crystal polyester, a mold release agent, a chopped glass fiber (“CS03JAPX-1”, manufactured by Owens Corning Corporation), talc (“X-50”, manufactured by NIPPON TALC Co., Ltd.) and mica (“AB-25S”, manufactured by Yamaguchi Mica Co., Ltd.) were fed into a unidirectionally rotating twin-screw extruder provided with a vent portion (“PCM-30”, manufactured by Ikegai Iron Works, Ltd.) according to the formulation shown in Table 1, melt-kneaded at 340° C. while maintaining the degree of decompression of the vent portion at the value shown in Table 1 and then pelletized to obtain a liquid crystal polyester composition. The liquid crystal polyester and the mold release agent were fed through a main feed port, while the chopped glass fiber, talc and mica were fed through a side feed port.

### Evaluation of Blister:

The obtained liquid crystal polyester composition was molded into a specimen of a mini-dumbbell (JIS K7113_{—}1(1/2)) using an injection molding machine (“Model ES-400”, manufactured by Nissei Plastic Industrial Co., Ltd.) and immersed in a heated solder bath for 1 minute. The maximum temperature, at which the generation of deformation or blisters of the specimen was not observed, was regarded as a solder heat resistant temperature.

### Measurement of Mold Release Resistance

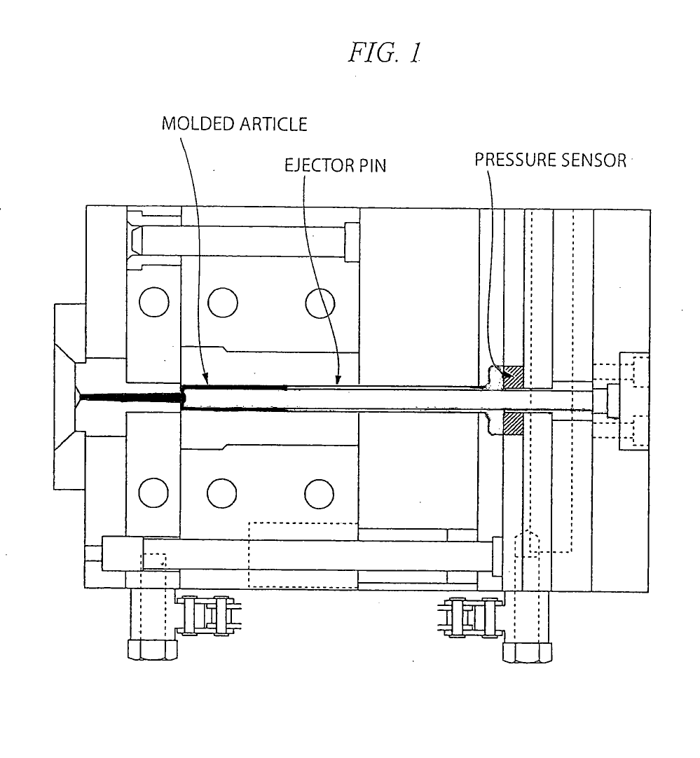

Using an injection molding machine (“Model ES-400”, manufactured by Nissei Plastic Industrial Co., Ltd.) and a mold shown in FIG. 1, the obtained liquid crystal polyester composition was injected into the mold shown in FIG. 1 at a constant injection rate under the conditions of a cylinder temperature of 350° C., a mold temperature of 130° C. and a dwell pressure of 1,400 kg/cm² or 1,700 kg/cm². Then, the pressure required to remove a specimen (specimen measuring 11 φ×15 φ×20 mm, having a draft angle of 0 in both core and cavity) from the interior of the mold was measured and this pressure was regarded as mold release resistance.

TABLE 1

| | | | | Comparative | Comparative | Comparative | | | Comparative |
|---|---|---|---|---|---|---|---|---|---|
| | | Example 1 | Example 2 | Example 1 | Example 2 | Example 3 | Example 3 | Example 4 | Example 4 |
| Liquid crystal | (Parts | 36 | 36 | 36 | 36 | 36 | 41 | 41 | 41 |
| polyester (1) | by mass) | | | | | | | | |
| Liquid crystal | (Parts | 29 | 29 | 29 | 29 | 29 | 34 | 34 | 34 |
| polyester (2) | by mass) | | | | | | | | |
| Mold release | (Parts | 0.3 | — | 0.3 | — | — | 0.3 | 0.3 | 0.3 |
| agent (1) | by mass) | | | | | | | | |
| Mold release | (Parts | — | 0.3 | — | 0.3 | — | — | — | — |
| agent (2) | by mass) | | | | | | | | |
| Chopped glass | (Parts | 22 | 22 | 22 | 22 | 22 | — | — | — |
| fiber | by mass) | | | | | | | | |
| Talc | (Parts | 13 | 13 | 13 | 13 | 13 | — | — | — |
| | by mass) | | | | | | | | |
| Mica | (Parts | — | — | — | — | — | 25 | 25 | 25 |
| | by mass) | | | | | | | | |
| Degree of | (MPa) | −0.07 | −0.07 | −0.05 | −0.05 | −0.07 | −0.07 | −0.08 | −0.05 |
| decompression of | | | | | | | | | |
| vent portion | | | | | | | | | |
| Solder heat | (° C.) | 280 | 280 | 260 | 260 | 260 | 270 | 280 | 260 |
| resistant | | | | | | | | | |
| temperature | | | | | | | | | |
| Mold release | (kg/cm²) | 10 | 60 | 10 | 60 | 200 | 39 | 39 | 39 |
| resistance | | | | | | | | | |
| (Dwell pressure: | | | | | | | | | |
| 1,400 kg/cm²) | | | | | | | | | |
| Mold release | (kg/cm²) | 15 | 80 | 15 | 80 | 500 | 49 | 49 | 49 |
| resistance | | | | | | | | | |
| (Dwell pressure: | | | | | | | | | |
| 1,400 kg/cm²) | | | | | | | | | |

What is claimed is:

1. A method for producing a liquid crystal polyester composition, the method comprising feeding a liquid crystal polyester and a polyhydric alcohol fatty acid ester into an extruder having a vent portion, followed by melt-kneading in a state where the degree of decompression of the vent portion is −0.06 MPa or less in terms of a gauge pressure.

2. The method according to claim 1, wherein the feed amount of the polyhydric alcohol fatty acid ester is from 0.1 to 1 part by mass based on 100 parts by mass of the liquid crystal polyester.

3. The method according to claim 1, wherein a 5% weight loss temperature of the polyhydric alcohol fatty acid ester determined by thermogravimetric analysis is 250° C. or higher.

4. The method according to claim 1, wherein the liquid crystal polyester has a flow initiation temperature of 280° C. or higher.

5. A method for producing a liquid crystal polyester molded article, the method comprising a step of molding the liquid crystal polyester composition which has been obtained by the method according to claim 1.

6. The method according to claim 5, wherein the liquid crystal polyester molded article is a molded article having a thin wall portion with a thickness of 1 mm or less.
